(19) United States
(12) Patent Application Publication
(10) Pub. No.: US 2017/0306868 A1
(43) Pub. Date: Oct. 26, 2017

(54) METHOD AND SYSTEM FOR CONTROLLING FUEL SUPPLY OF DUAL-FUEL VEHICLE

(71) Applicants: CHERY AUTOMOBILE CO., LTD, Wuhu (CN); WUHU POWER-TECHNOLOGY RESEARCH CO., LTD., Wuhu (CN)

(72) Inventor: Weiyi TANG, Wuhu (CN)

(21) Appl. No.: 15/520,600

(22) PCT Filed: Sep. 29, 2015
(86) PCT No.: PCT/CN2015/091108

§ 371 Date: Apr. 20, 2017

(30) Foreign Application Priority Data
Oct. 23, 2014 (CN) 201410572300.7

(51) Int. Cl. F02D 41/00; F02D 19/06; F02D 41/22

(52) U.S. Cl. CPC F02D 41/0025; F02D 41/222; F02D 19/0623; F02D 2041/223

(57) ABSTRACT

Embodiments of the present invention provide a method and a system for controlling fuel supply of a dual-fuel vehicle. The method includes: detecting an operation status of a pressure sensor by an electronic control unit, when an engine is at a gas state; receiving a pressure signal of the pressure sensor by the electronic control unit, when the pressure sensor works properly, the pressure signal indicating internal pressure of a gas tank; and controlling the engine to switch to fuel state by the electronic control unit, when the duration time of the internal pressure of the gas tank less than or equal to a predetermined pressure is greater than or equal to a predetermined time. The method can accurately control switching states according to the remainder of the gas in the gas tank, therefore avoid the engine frequent gas-fuel.

The present application claims the priority of Chinese Patent Application No. 201410572300.7, filed in Chinese Patent Office on Oct. 23, 2014 and entitled “METHOD AND SYSTEM FOR CONTROLLING FUEL SUPPLY OF DUAL-FUEL VEHICLE”, the entire contents of which are incorporated herein by reference.

### TECHNICAL FIELD

The present invention relates to the technical field of vehicle controls, particularly to a method and a system for controlling fuel supply of a dual-fuel vehicle.

### BACKGROUND

Compressed natural gas (CNG) is a cleaner energy compared with gasoline fuel. The exhaust emission level of the new-energy vehicles consuming natural gas drops dramatically. The natural gas enters the engine at a gas state, and can be mixed with air evenly for more complete combustion. Thus, the thermal circulation efficiency can be improved, and the combustion speed can be accelerated, resulting in full utilization of the thermal energy. Meanwhile, since the CNG has a higher octane rating than the gasoline, the antiknock characteristic of the CNG is relatively high. In addition, the natural gas price is lower but more stable than the gasoline price. Therefore, gasoline-CNG dual-fuel vehicles begin to attract more and more attention gradually.

Usually, an existing gasoline-CNG dual-fuel system determines the residual amount of the gas based on a high-pressure sensor signal of a gas tank, to inform users to replenish the gas. Therefore, an engine electronic control unit (ECU) can evaluate the condition of switching between the gas and fuel states, in accordance with the high pressure of the gas tank, when the gas is completely consumed. Such that, the ECU controls the exiting from a CNG combustion mode in accordance with the gas pressure of a high-pressure sensor signal of a CNG tank. When the signal is served as the exiting determination condition, it is compared and evaluated in the form of a single value. Due to the measurement accuracy reduction of the high-pressure sensor when the gas pressure is low, the voltage signal fluctuation can cause the pressure signal output fluctuation. The ECU merely executes automatically switching by identifying whether the high-pressure signal satisfies the CNG combustion condition. The high-pressure signal fluctuation is most likely to trigger the phenomenon of engine frequent gasoline-CNG switching when approaching the pressure threshold for exiting the CNG mode. This phenomenon not only seriously impacts user driving experience, but also results in safety hazards.

### SUMMARY

In order to avoid the phenomenon of frequent gas-fuel switching when the high pressure of the gas tank approaching the pressure threshold for exiting the gas state, embodiments of the present invention provides a method and a system for controlling fuel supply of a dual-fuel vehicle. The proposed techniques are as follows:

At an aspect, the embodiment of the present invention provides a method for controlling fuel supply of a dual-fuel vehicle, comprising:

detecting an operation status of a pressure sensor by an electronic control unit, when an engine is at a gas state;

receiving a pressure signal of the pressure sensor by the electronic control unit, when the pressure sensor works properly, the pressure signal indicating internal pressure of a gas tank; and

controlling the engine to switch to fuel state by the electronic control unit, when the duration time of the internal pressure of the gas tank less than or equal to a predetermined pressure is greater than or equal to a predetermined time.

Specifically, detecting operation status of the pressure sensor by the electronic control unit includes:

transmitting a diagnostic signal to the pressure sensor by the electronic control unit; and

feedbacking a detection signal to the electronic control unit in accordance with the diagnostic signal, the detection signal indicating the operation status of the pressure sensor.

Additionally, when the detection signal indicates an abnormal operation status of the pressure sensor, the method further comprising: Sending a fault alarm through an alarm unit controlled by the electric control unit.

Furthermore, when the internal pressure of the gas tank is greater than the predetermined pressure, or the duration time of the internal pressure of the gas tank less than or equal to the predetermined pressure is less than the predetermined time, the engine is maintained at the gas state.

At another aspect, the embodiments of the predetermined invention provide a system for controlling fuel supply of a dual-fuel vehicle, comprising an electric control unit and a pressure sensor, the electrical control unit is configured to:
when an engine is at a gas state, detect an operation status of the pressure sensor,
when the pressure sensor works properly, receive a pressure signal input by the pressure sensor, the pressure signal indicating an internal pressure of a gas tank, and
when the duration time of the internal pressure of the gas tank less than or equal to a predetermined pressure is greater than or equal to a predetermined time, control the engine to switch to a fuel state.

Specifically, the pressure sensor is configured to:

receive a diagnostic signal from the electric control unit, and

in accordance with the diagnostic signal, feedback a detection signal to the electronic control unit, the detection signal indicating the operation status of the pressure sensor.

Furthermore, the system of the fuel supply control for the dual-fuel vehicle comprising:

an alarm unit is configured to send a fault alarm, when the detection signal indicates an abnormal operation status of the pressure sensor.

In the method and the system for controlling fuel supply of a dual-fuel vehicle provided in the embodiment of the present invention, when the engine is at the gas state and the pressure sensor works properly, the electronic control unit can receive the pressure signal input of the pressure sensor. If the duration time of the internal pressure of the gas tank less than or equal to a predetermined pressure, is greater than or equal to a predetermined time, the electronic control unit can determine that the gas of the gas tank cannot satisfy the normal combustion requirement, therefore can effectively control the engine to switch to the fuel state. The method can accurately control switching states according to the remainder of the gas in the gas tank, so as to avoid the phenomenon of engine frequent gas-fuel switching due to the signal fluctuation when the internal pressure of the gas tank approaching the pressure threshold for exiting, resulting in significant improvement of user driving experience and safety.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a flowchart of a method for controlling fuel supply of a dual-fuel vehicle according to an embodiment of the present invention.

FIG. 2 is a flowchart of decision of a method of fuel supply control of a dual-fuel vehicle according to an embodiment of the present invention.

FIG. 3 is a schematic of structure of a system for controlling fuel supply of a dual-fuel vehicle according to an embodiment of the present invention.

### DETAILED DESCRIPTION

To make the objectives, technical solutions, and advantages of the present disclosure clearer, embodiments of the present disclosure are described in detail below with reference to the accompanying drawings.

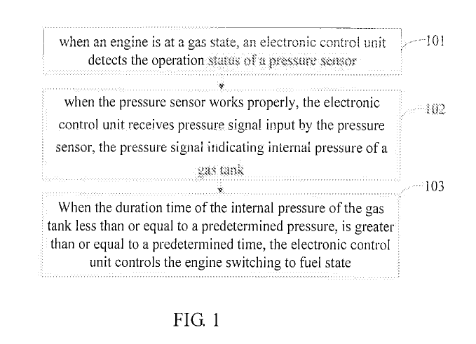

A method for control ling fuel supply of a dual-fuel vehicle provided in an embodiment of the present invention, as shown in FIG. 1, comprises:

Step 101, when an engine is at a gas state, an electronic control unit detects the operation status of a pressure sensor;

Step 102, when the pressure sensor works properly, the electronic control unit receives a pressure signal input by the pressure sensor, the pressure signal indicating internal pressure of a gas tank; and

Step 103, when the duration time of the internal pressure of the gas tank less than or equal to a predetermined pressure, is greater than or equal to a predetermined time, the electronic control unit controls the engine to switch to fuel state.

In the dual-fuel vehicle fuel supply control method provided in the embodiment of the present invention, when the engine is at the gas state and the pressure sensor works properly, the electronic control unit can receive the pressure signal input by the pressure sensor. If the duration time of the internal pressure of the gas tank less than or equal to the predetermined pressure, is greater than or equal to the predetermined time, the electronic control unit can determine that the gas of the gas tank cannot satisfy the normal combustion requirement, therefore effectively control the engine to switch to the fuel state. The method can accurately control gas-fuel switching according to the remainder of the gas in the gas tank, so as to avoid engine frequent gas-fuel switching due to signal fluctuation when the gas pressure of the gas tank approaching pressure threshold for exiting the gas state, resulting in improvement of user driving experience and safety.

It's important to note that in the embodiments of the present invention, dual-fuel can refer to gas (CNG) and fuel (gasoline). A single electronic control unit (ECU) can be utilized for gas control and fuel control, such as, the gas control and the fuel control can share the same engine control unit. In the CNG state, all of the relevant signals of the gas system are involved in the ECU process.

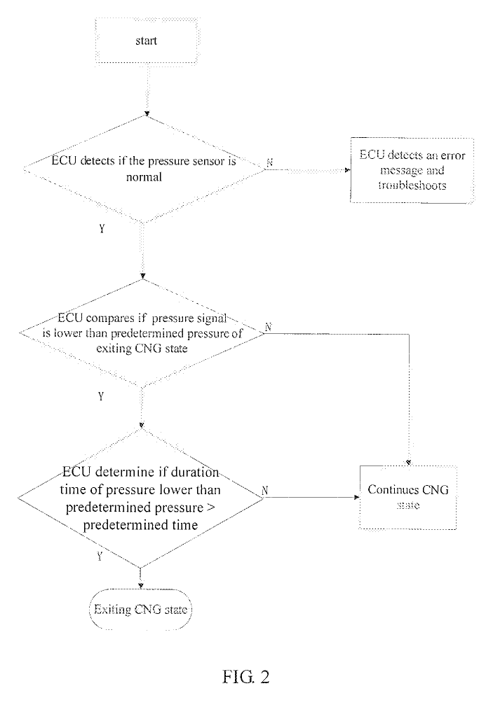

The embodiment of the present invention provides a flowchart of a method for controlling fuel supply of a dual-fuel vehicle as shown in FIG. 2.

Wherein, detecting the operation status of the pressure sensor by the ECU may include:

transmitting a diagnostic signal to the pressure sensor by the electronic control unit.

In the embodiment of the present invention, the pressure sensor operation status may include two status, a normal operation status and an abnormal operation status (also known as a non-normal operation status). Thus, a detection signal may indicate the normal operation status or the abnormal operation status of the pressure sensor. When the electronic control unit receives the detection signal indicating the normal operation status of the pressure sensor, the pressure sensor operates properly. When the ECU receives the detection signal indicating the abnormal operating status of the pressure sensor, the pressure sensor operates improperly, and a corresponding troubleshooting can be required.

Further, when the detection signal indicates the abnormal operation status of the pressure sensor, the electronic control unit may control an alarm unit to transmit a fault alarm.

Specifically, the current ECU usually can include a component diagnostic function. In accordance with the ECU component diagnostic function, the ECU can diagnose the rationality of the pressure sensor of the gas tank and the pressure signal thereof, and determine whether the pressure signal output is irrational, abnormal high, or abnormal low. The ECU can further determine whether the high-pressure sensor of the gas tank operates properly. If the current high-pressure sensor of the gas tank malfunctions, the ECU can report the corresponding failure code promptly, and warn the users to inspect the pressure sensor or the circuit thereof and to troubleshoot promptly.

In the embodiment of the present invention, when the pressure sensor works properly, the ECU can determine that the pressure signal acquired by the ECU is reliable. The predetermined pressure compared with the internal pressure of the gas tank indicated by the pressure signal can be selected according to the real time situation. For example, in accordance with engine working environment, the gas tank operation characteristics, and the user practical situation, the ECU can reasonably determine that the remainder gas of the gas tank does not satisfy the normal combustion requirement, thereby a minimum predetermined pressure can be set. The minimum predetermined pressure in the embodiment of the present invention may be, but not limited to, a fixed value (such as 0.1 MPa), or a range of values (such as 0.05-2.5 MPa).

In order to implement a delay comparison of the pressure signal, a delay feature of the comparison of the pressure signal can be added in ECU strategy structure. According to the reliable pressure signal acquired by the ECU, the pressure recorded by the pressure signal can be compared with the minimum predetermined pressure of exiting the CNG mode due to the low pressure, and the duration time of the pressure lower than the minimum predetermined pressure is compared with the predetermined time T. If the duration time of the internal pressure of the gas tank lower than the predetermined pressure is greater than or equal to the predetermined time T, the ECU can determine that the condition of exiting the CNG mode is satisfied, and continue executing the control function of switching to the gasoline state. If the duration of the internal pressure of the gas tank lower than the predetermined pressure is less than the predetermined time T, the ECU can determine to remain at the gas state. Wherein, the predetermined time T should be reasonably set according to the real-time situation, not being too short or too long. If the predetermined time T is too short, the problem of the frequent gas-fuel switching due to the pressure fluctuation can still occur. If the predetermined time T is too long, the real pressure of the gas tank is too low not to satisfy the current combustion requirement, the CNG state can be maintained, resulting in the engine's short-term shake or shut down.

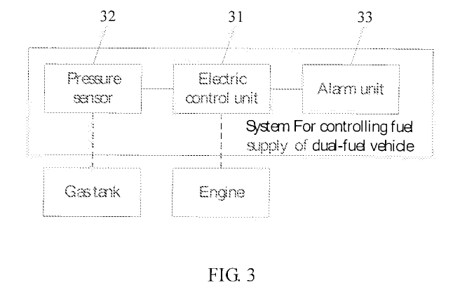

The dual-fuel vehicle fuel supply control system provided in the embodiment of the present invention, as shown in FIG. 3, can comprise an electronic control unit 31 and a pressure sensor 32, wherein the electronic control unit 31 may be configured to:

when the engine is at the gas state, detect the operation status of the pressure sensor 32,

when the pressure sensor 32 works properly, receive the pressure signal input by the pressure sensor 32, the pressure signal indicating the internal pressure of the gas tank, and

when the duration of the internal pressure of the gas tank lower than or equal to the predetermined pressure is greater than or equal to the predetermined time, control the engine to switch to the fuel state.

The dual-fuel vehicle fuel supply control system provided in the embodiment of the present invention, when the engine is at the gas state and the pressure sensor works properly, the electronic control unit can receive the pressure signal input by the pressure sensor. If the duration time of the internal pressure of the gas tank less than or equal to the predetermined pressure, is greater than or equal to the predetermined time, the electronic control unit can determine that the gas of the gas tank cannot satisfy the normal combustion requirement, therefore can effectively control the engine to switch to the fuel state. The method can accurately control gas-fuel switching according to the remainder of the gas in the gas tank, so as to avoid the phenomenon of engine frequent gas-fuel switching due to the signal fluctuation when the internal pressure of the gas tank approaching the pressure threshold of exiting gas state, resulting in significant improvement of user driving experience and safety.

Further, the pressure sensor 32 may be configured to:

receive the diagnostic signal transmitted by the electronic control unit 31; and

feedback the detection signal to the electronic control unit 31 in accordance with the diagnostic signal, the detection signal indicating the operation status of the pressure sensor 32.

Further, as shown in FIG. 3, the dual-fuel vehicle fuel supply control system may further comprise:

an alarm unit 33 is configured to send the fault alarm, when the detection signal indicates the abnormal operation status of the pressure sensor 32.

To those of ordinary skill in the art, whole or portion of the implementation steps described above in the embodiments of the present invention, can be achieved by hardware, or by programs instructing the corresponding hardware. The programs may be stored in a computer readable storage medium. The computer readable storage medium may be a read-only memory, magnetic or optical disk.

Described above are merely exemplary embodiments of the present disclosure, but are not intended to limit the present disclosure. Any modification, equivalent replacement, or improvement made without departing from the spirit and principle of the present disclosure should fall within the protection scope of the present disclosure.

What is claimed is:

1. A method for controlling fuel supply of a dual-fuel vehicle, comprising:
detecting an operation status of a pressure sensor by an electronic control unit, when an engine is at a gas state;
receiving a pressure signal of the pressure sensor by the electronic control unit, when the pressure sensor works properly, the pressure signal indicating internal pressure of a gas tank; and
controlling the engine to switch to fuel state by the electronic control unit, when the duration time of the internal pressure of the gas tank less than or equal to a predetermined pressure is greater than or equal to a predetermined time.

2. The method according to claim 1, wherein detecting the operation status of the pressure sensor by the electronic control unit comprises:
transmitting a diagnostic signal to the pressure sensor by the electronic control unit, and
feedbacking a detection signal to the electronic control unit in accordance with the diagnostic signal, the detection signal indicating the operation status of the pressure sensor.

3. The method according to claim 2 further comprising:
Sending a fault alarm through an alarm unit controlled by the electric control unit, when the detection signal indicates an abnormal operation status of the pressure sensor.

4. The method according to claim 2, further comprising:
maintaining the engine at the gas state, when the internal pressure of the gas tank is greater than the predetermined pressure, or the duration of the internal pressure of the gas tank less than or equal to the predetermined pressure is less than the predetermined time.

5. A system for controlling fuel supply control of a dual-fuel vehicle, comprising:
a pressure sensor; and
an electric control unit configured to:
detect an operation status of the pressure sensor, when an engine is at gas state,
receive a pressure signal of the pressure sensor when the pressure sensor works properly, the pressure signal indicates internal pressure of a gas tank, and
control the engine to switch to fuel state when duration of the internal pressure of the gas tank less than or equal to a predetermined pressure is greater than or equal to a predetermined time.

6. The system according to claim 5, wherein the pressure sensor is configured to:
receive a diagnostic signal from the electric control unit, and
feedback a detection signal to the electronic control unit in accordance with the diagnostic signal, the detection signal indicating the operation status of the pressure sensor.

7. The system according to claim 6 further comprising:
an alarm unit configured to send a fault alarm, when the detection signal indicates an abnormal operation status of the pressure sensor.
